(19) United States
(12) Patent Application Publication
(10) Pub. No.: US 2009/0244768 A1
(43) Pub. Date: Oct. 1, 2009

(54) MAGNETIC HEAD POSITIONING CONTROL METHOD AND MAGNETIC HEAD POSITIONING CONTROL APPARATUS

(75) Inventor: Tsugito Maruyama, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/268,808

(22) Filed: Nov. 11, 2008

(30) Foreign Application Priority Data
Mar. 25, 2008 (JP) 2008-77027

(51) Int. Cl. G11B 5/596

(52) U.S. Cl. 360/77.04; G9B/5.216

(57) ABSTRACT

N groups of servo patterns, each corresponding to the predetermined number of servo sectors, are recorded in a magnetic disk. The magnetic head positioning control apparatus of the present invention produces an RRO current correction table corresponding to each group of servo patters and selects the group of servo patterns that is the best in transferred quality of the sevro pattern as SPopt. For servo sectors (target servo sectors) corresponding to other groups of servo patterns and existing between two adjacent servo sectors corresponding to the SPopt, the magnetic head positioning control apparatus calculates an RRO current correction amount corresponding to the target servo sector by a linear interpolation calculation using the RRO current correction amount corresponding to each of the adjacent servo sectors in the RRO current correction table corresponding to the SPopt to perform the magnetic head positioning control based on the calculated RRO current correction amount.

### CROSS-REFERENCE TO RELATED APPLICATIONS

This application claims the conventional priority based on Japanese Application No. 2008-077027, filed on Mar. 25, 2008, the disclosures of which are incorporated herein by reference.

### BACKGROUND OF THE INVENTION

1. Field of the Invention The present invention relates to a magnetic head positioning control method and a magnetic head positioning control apparatus, and in particular, to a magnetic head positioning control method and a magnetic head positioning control apparatus performing a magnetic head positioning control between servo sectors accurately.

2. Description of the Related Art

For a head positioning control in a magnetic disk apparatus, a magnetic head in the magnetic disk apparatus reads a servo pattern recorded on the magnetic disk to be positioned. For example, when a servo pattern shown in FIG. 8B is recorded in a servo sector 101 on a magnetic disk 100 shown in FIG. 8A, the magnetic head is positioned based on the servo pattern shown in FIG. 8B. The servo sector 101 refers to an area where the servo pattern is written.

Until now, a positioning control of a magnetic head in a magnetic disk apparatus has been performed by a magnetic head positioning control system shown in FIG. 9, for example. As shown in FIG. 9, a conventional magnetic head positioning control apparatus performs a feedback control and a feed forward control so that an error “e” outputted from the magnetic head between a target position “r” of a magnetic head and an observation position “y” (the current position of a magnetic head) is minimized. In other words, the magnetic head positioning control apparatus causes a low-speed sampler (LS) 204 to sample the error “e” at a low speed and then inputs the sampled error to a feedback (FB) controller 201. The magnetic head positioning control apparatus adds the output of the FB controller 201 and an RRO current correction amount corresponding to the current sector number read from an RRO current correction table 202. Then, a low speed sampler (LS) 205 performs a low-peed sampling to determine a control input and inputs the control input to a control object 200 to perform a positioning control of the magnetic head. The control object 200 is, for example, a magnetic head positioning arm mechanism and a voice coil motor.

The RRO current correction table 202 stores an RRO current correction amount which is a correction amount of RRO current flowing into the control object 200 to reduce fluctuations in a magnetic head position due to RRO described later. That is to say, the RRO current correction amount stored in the RRO current correction table 202 is a correction amount for correcting fluctuations in a magnetic head position. As shown in FIG. 9, acceleration disturbance, position disturbance and RRO are applied to predetermined positions of the magnetic head positioning control system.

The control system shown in FIG. 9 reads an RRO target-value current correction amount corresponding to the current sector number from an RRO target amount correction table 203 and corrects a target position based on the RRO target-value correction amount. The RRO target-value correction amount is an amount for correcting a target position “r.”

There has been proposed a control system in which a difference between a target value and the present value of a control object is inputted to a low frequency band compensator, the output of the low frequency band compensator is inputted to a high frequency band compensator and the output of the high frequency band compensator is inputted to the control object, causing the target value to agree with the present value of a control object. The control system performs multi-rate feedback control so that the sampling rate outputted from the high frequency band compensator to the control object can be several times as high as the sampling rate at which the present value is obtained (refer to Japanese Patent Laid-Open No. 2001-296906 for example).

Factors disturbing the position of a magnetic head include non-repeatable run out (NRRO) and repeatable run out (RRO). The NRRO includes position disturbance such as demodulation noise, flutter and arm vibration and acceleration disturbance such as wind disturbance and external vibration. The RRO includes eccentricity of a servo pattern and one-round writing splicing at the time of writing the servo pattern in a magnetic disk. Typically, as in the conventional magnetic head positioning control system described with reference to FIG. 9, fluctuations in a magnetic head position due to the NRRO are reduced by a feedback control and fluctuations in a magnetic head position due to the RRO are reduced by a feedforward control.

In a magnetic transfer that is one of methods of recording a servo pattern in a magnetic disk, a transferred servo pattern is greater in RRO than the existing stack STW. FIG. 10 is a diagram describing a magnetic transfer process. FIG. 11 is a diagram showing the RRO of a servo pattern formed by the magnetic transfer process. The magnetic transfer is performed in the following manner. As shown at #1 in FIG. 10, the magnetic disk 100 is initialized. A sub-master (or, a member with irregularities corresponding to a servo pattern) is brought into close contact with the magnetic disk 100 (refer to #2 in FIG. 10) and a transfer magnetic field is applied thereto (refer to #3 in FIG. 10), completing the magnetic transfer (refer to #4 in FIG. 10).

The magnetic transfer causes RRO of a transferred servo pattern shown in FIG. 11 owing to RRO of a motor of a drawing apparatus and RRO resulted from NRRO, a distortion caused at the time of producing a sub-master and a distortion caused at the time of bringing a sub-master into close contact with a magnetic disk. The RRO is great in a high-frequency component in particular. For this reason, the RRO need reducing to improve the trackability of the magnetic head to the servo pattern.

Typically, as in the system described with reference to FIG. 9, an RRO current correction amount is added feed-forward-wise to the output of the feedback (FB) controller 201 to determine a control input to input the control input to the control object 200, thereby reducing the RRO in terms of control.

The magnetic head is freed (not controlled) between the servo sectors. As shown in a dotted-line elliptical portion in FIG. 8A, the position of the magnetic head fluctuates (swells) from a line in which adjacent servo sectors 101 are connected at an arc according to NRRO. The control system shown in FIG. 9 does not perform control to reduce fluctuations according to NRRO between the servo sectors. The number of servo sectors per one round may be increased to reduce the fluctuations as much as possible. However, it is difficult to increase the number of servo sectors per one round, because of compatibility with data format efficiency.

Then, the magnetic head positioning control system shown in FIG. 12 is conceivable. FIG. 12 shows a magnetic head positioning control system used in a background of the present invention. The magnetic head positioning control apparatus performing the control in accordance with the magnetic head positioning control system shown in FIG. 12 performs such a multi-rate feedback control as proposed in Japanese Patent Laid-Open No. 2001-296906. Specifically, the magnetic head positioning control apparatus causes a low speed sampler (LS) 304 to sample an error “e” at a low speed and then input the sampled error to a low frequency band feedback (FB) controller 301 and a high frequency band feedback (FB) controller 302. The low frequency band FB controller 301 is a low frequency band compensator for outputting a control signal to decrease fluctuations in the position of the magnetic head due to disturbance in a low frequency band. The high frequency band FB controller 302 is a high frequency band compensator for outputting a control signal to decrease fluctuations in the position of the magnetic head due to disturbance in a high frequency band. The magnetic head positioning control apparatus causes a high speed sampler (HS) 306 to sample the output of the high frequency band FB controller 302 at a high speed. The high speed sampler operates at a speed that is integer times as high as the low speed sampler and synchronously therewith. The magnetic head positioning control apparatus reads an RRO current correction amount corresponding to the current sector number from an RRO current correction table 303. Then, the magnetic head positioning control apparatus adds the output of the low frequency band FB controller 301 to the RRO current correction amount corresponding to the current sector number read from the RRO current correction table 303 and causes a low speed sampler (LS) 305 to perform sampling at a low speed. The magnetic head positioning control apparatus adds a high speed sampling result from the high speed sampler 306 to a low speed sampling result from the low speed sampler 305 to determine a control input and inputs the control input to the control object 200.

The control system described with reference to FIG. 12 does nothing about compensation of fluctuations in the position of the magnetic head due to RRO between the servo sectors. Therefore, the control system cannot accurately perform a magnetic head positioning control between the servo sectors.

Producing a servo pattern by the aforementioned magnetic transfer may cause dispersion and defect of quality of the pattern transferred on the magnetic disk due to writing splicing at the time of drawing, defective pattern at the time of producing a sub master, defect in which the sub-master is not brought into close contact to a magnetic disk at the time of magnetic transfer and dispersion of magnetic characteristics of the magnetic disk. Dispersion and defect of transferred quality produces a problem that sufficient on-track accuracy cannot be obtained or the servo pattern cannot be used.

### SUMMARY OF THE INVENTION

It is an object of the present invention to provide a magnetic head positioning control method for accurately performing a magnetic head positioning control between servo sectors.

It is another object of the present invention to provide a magnetic head positioning control apparatus for accurately performing a magnetic head positioning control between servo sectors.

The magnetic head positioning control method of the present invention is a magnetic head positioning control method in a magnetic head positioning control apparatus for controlling a magnetic head of a magnetic disk apparatus so that the magnetic head follows a servo pattern. The magnetic head positioning control method comprises providing a magnetic disk incorporated in the magnetic disk apparatus in which n groups of servo patterns, each corresponding to the predetermined number of servo sectors, are recorded, evaluating, in the magnetic head positioning control apparatus, the transferred quality of a servo pattern for each of the n groups of servo patterns, selecting the group of servo patterns that is the best in transferred quality as the best group of servo patterns, and performing a magnetic head positioning control using a correction amount in correction-amount storage unit corresponding to the selected best group of servo patterns, out of the correction-amount storage unit storing the correction amount corresponding to each of the n groups of servo patterns and correcting fluctuations in the position of a magnetic head in a servo sector to which a group of servo patterns corresponds.

Preferably, for the servo sector corresponding to the best group of servo patterns, performing, in the magnetic head positioning control apparatus, the magnetic head positioning control based on the correction amount in the correction-amount storage unit corresponding to the best group of servo patterns, and for a servo sector corresponding to other groups of servo patterns different from the best group of servo patterns and existing between two servo sectors corresponding to the best group of servo patterns, calculating, in the magnetic head positioning control apparatus, a correction amount corresponding to servo sector corresponding to other groups of servo sectors by a linear interpolation calculation using a correction amount corresponding to each of the two servo sectors in the correction-amount storage unit corresponding to the best group of servo patterns and performing the magnetic head positioning control based on the calculated correction amount.

Preferably, for the servo sector corresponding to the best group of servo patterns, performing, in the magnetic head positioning control apparatus, the magnetic head positioning control based on the correction amount in the correction-amount storage unit corresponding to the best group of servo patterns, and for the servo sectors corresponding to other groups of servo patterns different from the best group of servo patterns and existing between two servo sectors corresponding to the best group of servo patterns, performing, in the magnetic head positioning control apparatus, the magnetic head positioning control based on the correction amount in the correction-amount storage unit corresponding to other groups of servo patterns different from the best group of servo patterns.

The magnetic head positioning control apparatus of the present invention is a magnetic head positioning control apparatus which controls a magnetic head of a magnetic disk apparatus so that the magnetic head follows a servo pattern, wherein, n groups of servo patterns, each corresponding to the predetermined number of servo sectors, are recorded in a magnetic disk incorporated in the magnetic disk apparatus. The magnetic head positioning control apparatus comprises a quality evaluation unit evaluating the transferred quality of a servo pattern for each of the n groups of servo patterns and selecting the group of servo patterns that is the best in transferred quality as the best group of servo patterns, and a positioning control unit performing a magnetic head positioning control using a correction amount in correction-amount storage unit corresponding to the selected best group of servo patterns, out of a correction-amount storage unit storing the correction amount corresponding to each of the n groups of servo patterns and correcting fluctuations in the position of a magnetic head in a servo sector to which a group of servo patterns corresponds.

Preferably, for the servo sector corresponding to the best group of servo patterns, the positioning control unit performs the magnetic head positioning control based on the correction amount in the correction-amount storage unit corresponding to the best group of servo patterns, and for the servo sectors corresponding to other groups of servo patterns different from the best group of servo patterns and existing between two servo sectors corresponding to the best group of servo patterns, the positioning control unit calculates a correction amount corresponding to servo sector corresponding to other groups of servo sectors by a linear interpolation calculation using a correction amount corresponding to each of the two servo sectors in the correction-amount storage unit corresponding to the best group of servo patterns and performs the magnetic head positioning control based on the calculated correction amount.

Preferably, for the servo sector corresponding to the best group of servo patterns, the positioning control unit performs the magnetic head positioning control based on the correction amount in the correction-amount storage unit corresponding to the best group of servo patterns, and for the servo sectors corresponding to other groups of servo patterns different from the best group of servo patterns and existing between two servo sectors corresponding to the best group of servo patterns, the positioning control unit performs the magnetic head positioning control based on the correction amount in the correction-amount storage unit corresponding to other groups of servo patterns different from the best group of servo patterns.

The magnetic head positioning control method and the magnetic head positioning control apparatus select the group of servo patters best in transferred quality of servo pattern in n groups of servo patterns recorded in a magnetic disk as the best group of servo patterns and performs a magnetic head positioning control using a correction amount in correction-mount storage unit corresponding to the best group of servo patterns. Accordingly, the magnetic head positioning control method and the magnetic head positioning control apparatus can provide sufficient on-track accuracy.

For a servo sector corresponding to other groups of servo patterns between two servo sectors corresponding to the best group of servo patterns, the magnetic head positioning control method and the magnetic head positioning control apparatus calculate a correction amount corresponding to the servo sector corresponding to other groups of servo patterns by a linear interpolation calculation using a correction amount corresponding to each of the two servo sectors in the correction-amount storage unit corresponding to the best group of servo patterns and perform a magnetic head positioning control based on the calculated correction amount. Accordingly, the magnetic head positioning control method and the magnetic head positioning control apparatus can enables accurately compensating fluctuations in a magnetic head between servo sectors.

For a servo sector corresponding to other groups of servo patterns between two servo sectors corresponding to the best group of servo patterns, the magnetic head positioning control method and the magnetic head positioning control apparatus perform a magnetic head positioning control based on a correction amount in the correction-mount storage unit corresponding to the other groups of servo patterns. For this reason, for a servo sector existing between the servo sectors, it is possible to perform a magnetic head positioning control based on the measurement value of the correction amount corresponding to the servo sector stored in correction-mount storage unit in advance. As a result of this, it is possible to perform a highly accurate positioning control of the magnetic head between servo sectors.

### BRIEF DESCRIPTION OF THE DRAWINGS

FIG. 1 is a diagram showing a magnetic head positing control process using a magnetic head positioning control method according to the present embodiment.

FIG. 2 is a schematic diagram showing an example of groups of servo patterns recorded in a magnetic disk.

FIG. 3 is an example of an RRO current correction table.

FIG. 4 is a diagram showing a control system for producing the RRO current correction table.

FIG. 5 is a diagram showing a control system for selecting the best group of servo patterns.

FIGS. 6 and 7 are diagrams showing a structure of the magnetic head positioning control apparatus.

FIGS. 8A and 8B are diagrams showing an example of a servo pattern recorded on a magnetic disk.

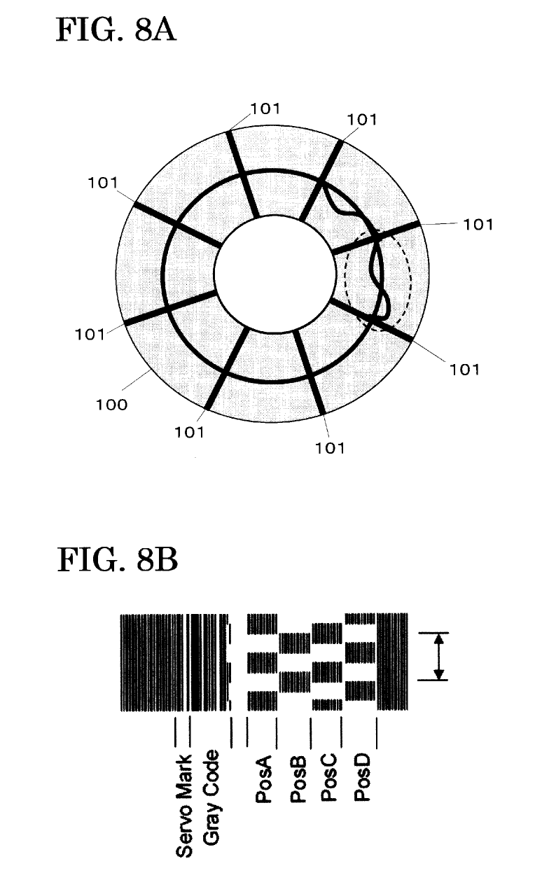

FIG. 9 is a diagram showing a magnetic head positing control of a conventional magnetic head device.

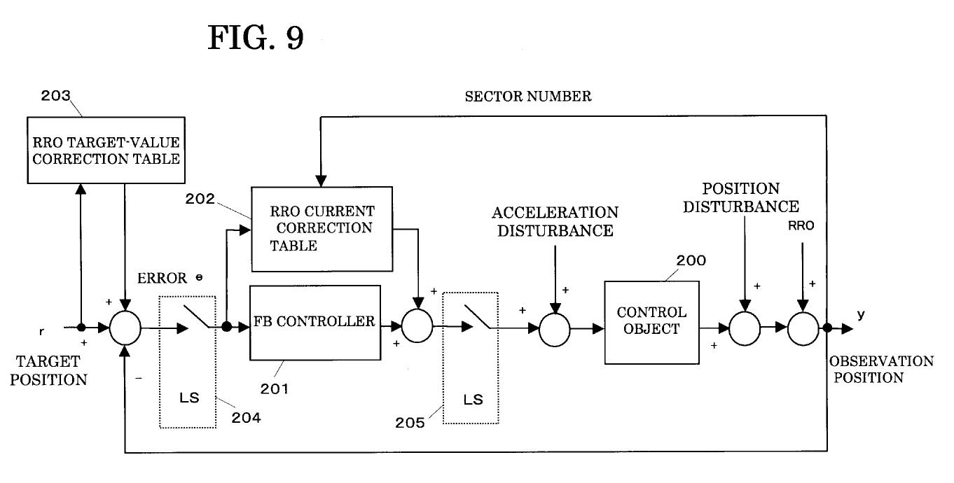

FIG. 10 is a diagram showing a magnetic transfer process.

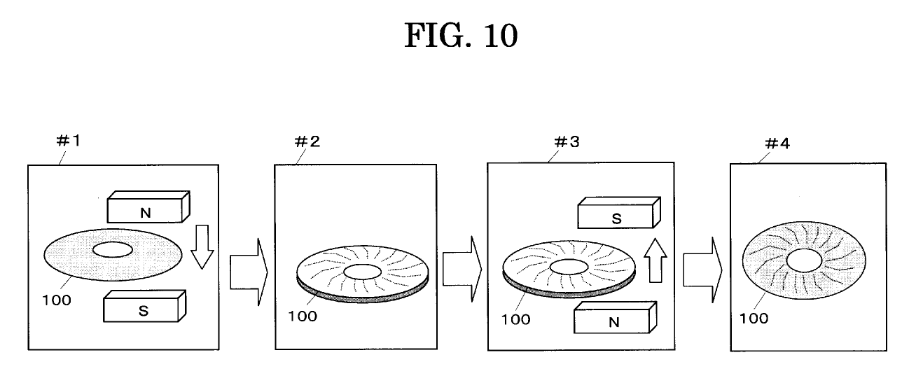

FIG. 11 is a diagram showing the RRO of a servo pattern formed by the magnetic transfer process.

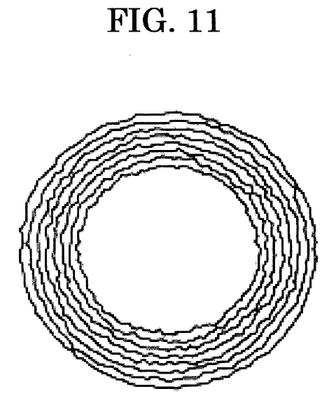

FIG. 12 is a diagram showing a magnetic head positioning control system used in a background of the present invention.

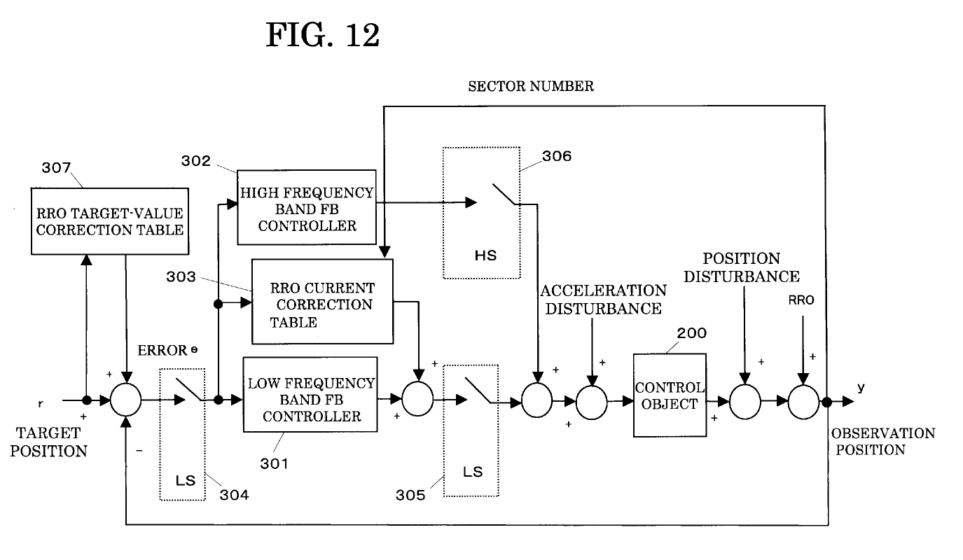

### DETAILED DESCRIPTION OF THE PREFERRED EMBODIMENTS

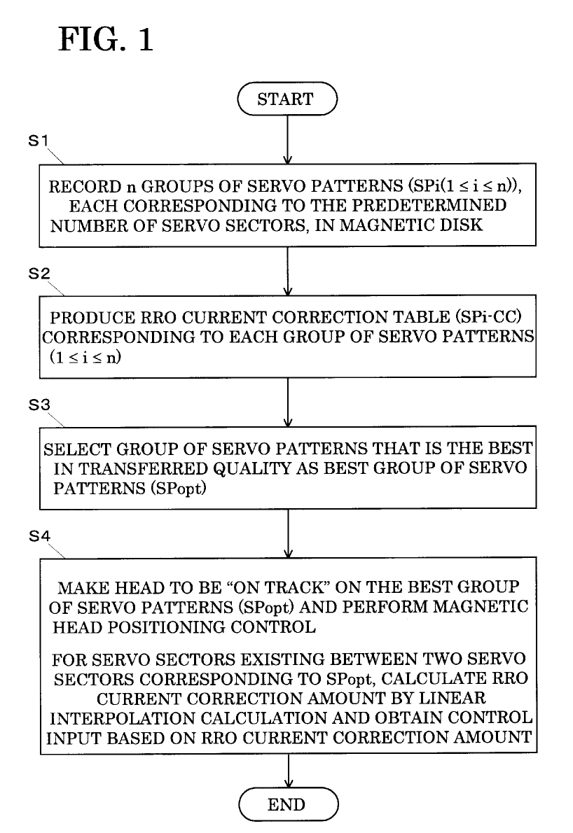

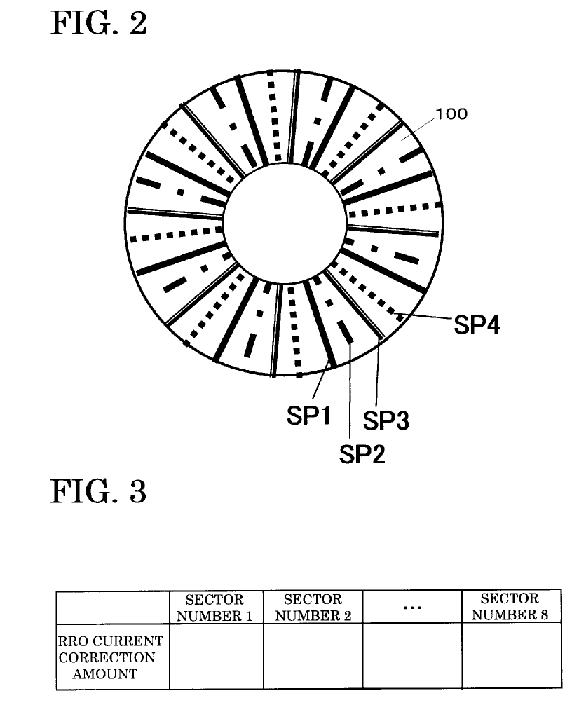

The present embodiments are described below with reference to the drawings. FIG. 1 is a diagram showing a magnetic head positing control process using the magnetic head positioning control method according to the present embodiment. First of all, n groups of servo patterns (SPi(1≦I≦n)), each having (corresponding to) the predetermined number of servo sectors, are recorded in a magnetic disk (step S1). FIG. 2 is a schematic diagram showing an example of groups of servo patterns recorded in a magnetic disk 100. FIG. 2 takes n=4 as an example. The servo patterns recorded in the eight servo sectors indicated by solid lines in FIG. 2 are a first group of servo patterns (SP1). The servo patterns recorded in the eight servo sectors indicated by alternate long and short dash lines in FIG. 2 are a second group of servo patterns (SP2). The servo patterns recorded in the eight servo sectors indicated by double lines in FIG. 2 are a third group of servo patterns (SP3). The servo patterns recorded in the eight servo sectors indicated by dotted lines in FIG. 2 are a fourth group of servo patterns (SP4).

The magnetic disk in which the n groups of servo patterns are recorded is incorporated in a magnetic disk apparatus. The magnetic head positioning control apparatus produces an RRO current correction table (SPi-CC) corresponding to each group of servo patterns (step S2). Specifically, the magnetic head positioning control apparatus makes a head to be “on track” on a servo pattern and performs a repetitive control described later on a group of servo pattern SPi basis to measure and calculate an RRO current correction amount in each servo sector corresponding to the group of servo patterns SPi. The magnetic head positioning control apparatus records the calculated RRO current correction amount in the RRO current correction table (SPi-CC). The process of step S2 may be performed by the magnetic head positioning control apparatus according to the present embodiment or by another control device different from the magnetic head positioning control apparatus. The RRO current correction table (SPi-CC) corresponds to SPi and correction-amount storage unit for storing an RRO current correction amount that corrects fluctuations in the position of a magnetic head in each servo sector to which SPi corresponds.

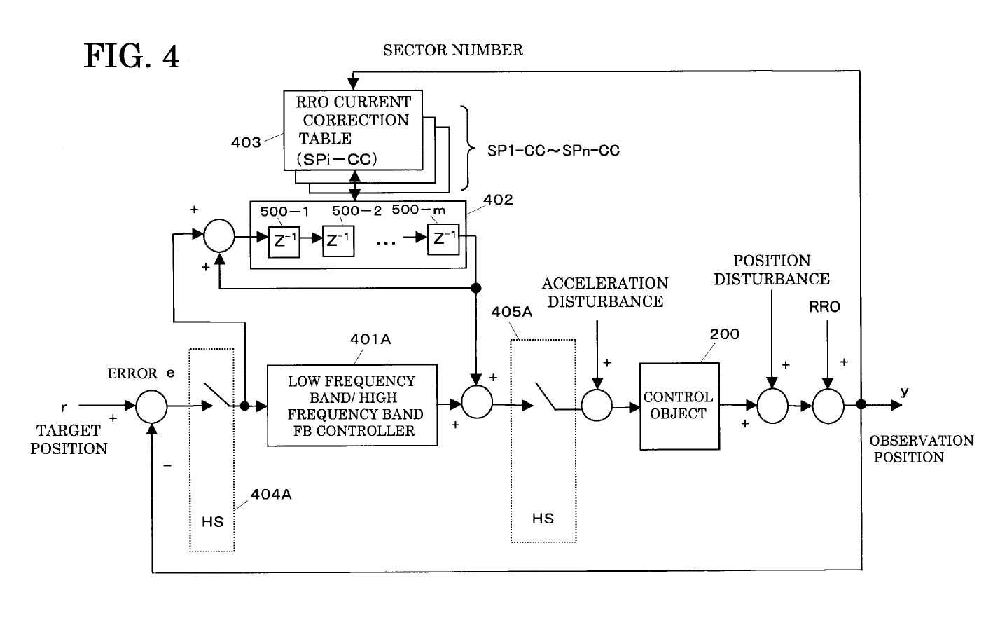

FIG. 3 is an example of the RRO current correction table (SPi-CC). The sector numbers 1, 2, . . . , 8 in the RRO current correction table shown in FIG. 3 indicate eight servo sectors corresponding to the group of servo patterns SPi. As shown in FIG. 3, the RRO current correction amount in each servo sector corresponding to the SPi is recorded in the SPi-CC.

A quality evaluation unit (for example, a quality evaluation unit 406) of the magnetic head positioning control apparatus according to the present embodiment evaluates the transferred quality of a servo pattern on a group of servo pattern SPi basis to select the group of servo patterns that is the best in transferred quality as the best group of servo patterns (SPopt) (step S3). The RRO current correction table corresponding to the SPopt selected at the step S3 is the best RRO current correction table (SPopt-CC). The head is made to be “on track” on the best group of servo patterns (SPopt) and a predetermined positioning control unit (not shown) with which the magnetic head positioning control apparatus is provided determines a control input to be inputted to the control object. The positioning control unit inputs the control input to the control object to perform the magnetic head positioning control (step S4). Specifically, for the servo sector corresponding to the SPopt, the positioning control unit determines the control input based on the RRO current correction amount in the best RRO current correction table (SPopt-CC) and inputs the determined control input to the control object to perform the magnetic head positioning control. For servo sectors (target servo sectors) corresponding to other groups of servo patterns SPi different from the SPopt and existing between two servo sectors (for example, two adjacent servo sectors) corresponding to the SPopt, the positioning control unit calculates the RRO current correction amount corresponding to the target servo sector by a linear interpolation calculation using the RRO current correction amount in each of the two servo sectors. The positioning control unit determines the control input based on the calculated RRO current correction amount and inputs the determined control input to the control object to perform the magnetic head positioning control.

According to another embodiment of to the present invention, for the target servo sector, the positioning control unit determines the control input based on the RRO current correction amount in the RRO current correction table (SPi-CC) corresponding to the group of servo patterns SPi to which the target servo sector corresponds and inputs the control input to the control object to perform the magnetic head positioning control.

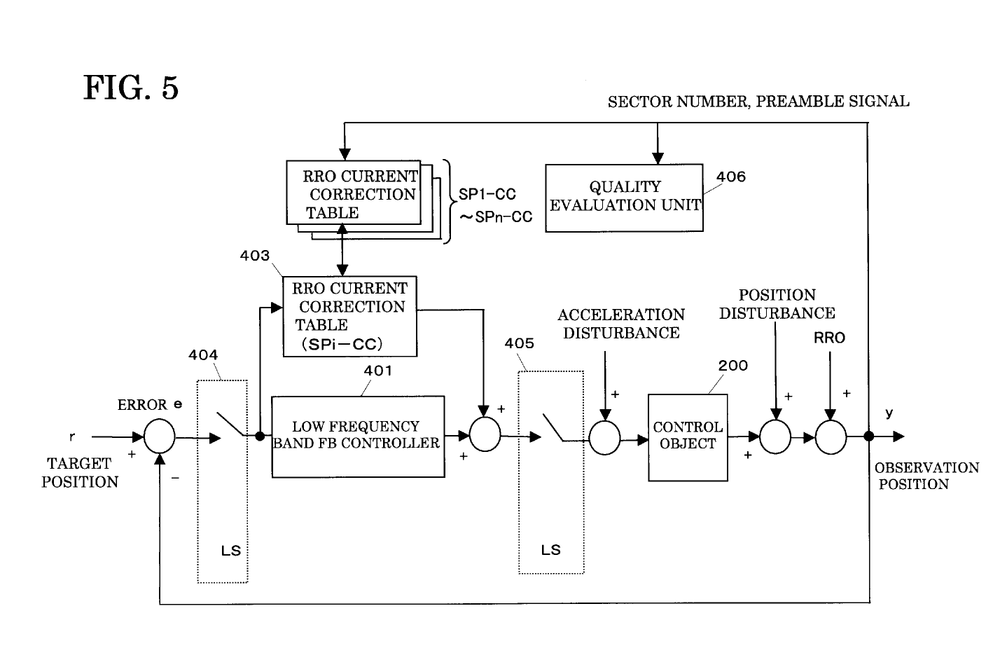

FIG. 4 is a diagram showing a control system for producing the RRO current correction table (SPi-CC) corresponding to each group of servo patterns SPi at the step S2 in FIG. 1. The magnetic head positioning control apparatus of the present embodiment causes a high-speed sampler (HS) 404A to sample an error “e” at a high speed and inputs the sampled error to a low frequency band/high frequency band FB controller 401A. The low frequency band/high frequency band FB controller 401A outputs, for example, a control signal to decrease fluctuations in the position of the magnetic head due to disturbance in a low frequency band. The magnetic head positioning control apparatus adds the output of the low frequency band/high frequency band FB controller 401A to the RRO current correction amount outputted from a repetitive control unit 402. The magnetic head positioning control apparatus causes a high-speed sampler (HS) 405A to sample the added result at a high speed to determine the control input to be inputted to the control object 200.

The repetitive control unit 402 includes time delay operators 500-1 to 500-m equal in number to the servo sectors (m servo sectors, for example) corresponding to the group of servo patterns SPi. The time delay operator causes a time delay corresponding to time required for the magnetic head to move from one servo pattern to the next.

The time during which the magnetic head moves onto a servo sector and then a magnetic disk turns through one revolution to move again the magnetic head onto the same servo sector is referred to as a “moving period of a magnetic head.” When a magnetic head moves onto a servo sector with a sector number 1 at a first period, the magnetic head outputs an error “e” to the repetitive control unit 402. The time delay operator 500-1 of the repetitive control unit 402 stores the error “e” in the SPi-CC as an RRO current correction amount (RRO1) corresponding to the servo sector with a sector number 1 in an RRO current correction table (SPi-CC) 403. When the magnetic head moves onto a servo sector with a sector number 2, the time delay operator 500-1 transfers the information of the RRO1 to the next time delay operator 500-2 to cause the next time delay operator 500-2 to store the information. The time delay operator 500-1 stores the error “e” at that point in the SPi-CC as an RRO current correction amount corresponding to the servo sector with a sector number 2. Similarly, each time the magnetic head sequentially moves onto each servo sector, the RRO1 is transferred to the following time delay operator. As a result, when the magnetic head moves onto the last (m-th) servo sector at the first period, the RRO1 is transferred to the time delay operator 500-m and the time delay operator 500-m stores the RRO1.

At a second period, when the magnetic disk moves again onto the servo sector with a sector number 1, the time delay operator 500-m outputs the information of the RRO1 stored at the first period. The outputted RRO1 is added to the output of the low frequency band FB controller 401. The time delay operator 500-1 of the repetitive control unit 402 temporarily stores a value in which the outputted RRO1 is added to the error “e” at that point. The RRO1 stored in the SPi-CC is updated by the value temporarily stored in the time delay operator 500-1.

That is, the repetitive control unit 402 repeats for a predetermined number of periods a process described as follows. In the process, for each of the servo sectors corresponding to the SPi, the repetitive control unit 402 adds an error in the period preceding the current period to the error in the current period to determine the RRO current correction amount at the current moment, and updates the RRO current correction amount in the period preceding the current period by the RRO current correction amount determined at the current moment to produce the final RRO current correction table (SPi-CC) corresponding to the SPi. The repetitive control unit 402 performs the above process for producing the RRO current correction table (SPi-CC) for all the groups of servo patterns to produce the final RRO current correction table (SP1-CC to SPn-CC). Each of the final RRO current correction tables corresponds to each of the groups of servo patterns (SP1 to SPn), respectively.

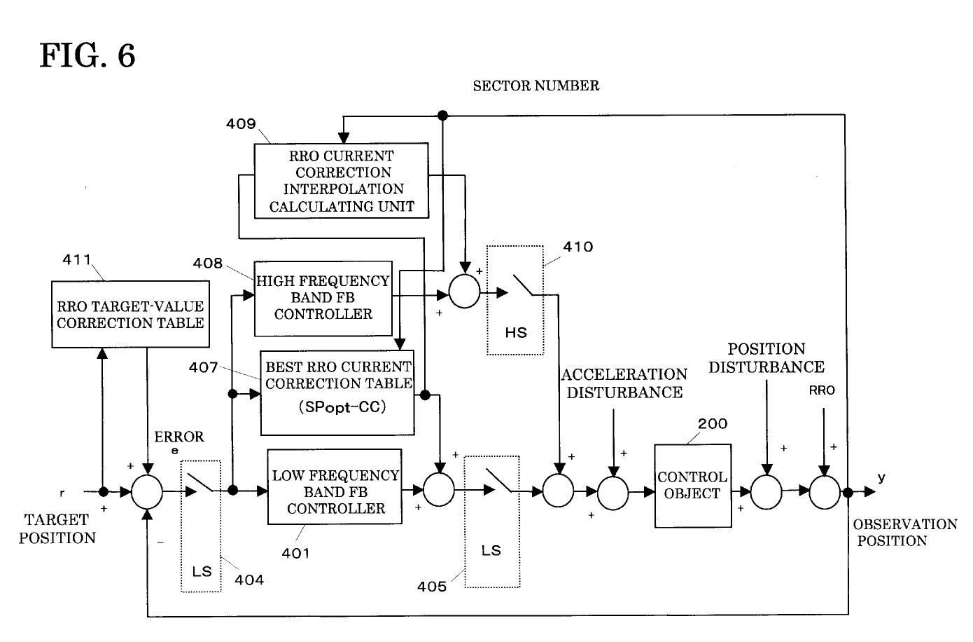

FIG. 5 is a diagram showing a control system for selecting the best group of servo patterns SPopt at step S3 in FIG. 1. As shown in FIG. 5, a predetermined processing unit of the magnetic head positioning control apparatus of the present embodiment selects one RRO current correction table (SPi-CC) from all the RRO current correction tables (SP1-CC to SPN-CC) as a selection table and adds the RRO current correction amount in the selection table to the output of the low frequency band FB controller 401 to determine the control input to be inputted to the control object 200. The magnetic head inputs an error “e” to the quality evaluation unit 406 of the magnetic head positioning control apparatus of the present embodiment. The quality evaluation unit 406 evaluates and determines transferred quality (transferred quality of a servo pattern) corresponding to the SPi based on the inputted error “e.” The quality evaluation unit 406 calculates a repeatable position error (RPE) based on, for example, the inputted error “e” inputted from the magnetic head to determine the calculated RPE as transferred quality corresponding to the group of servo patterns SPi. The quality evaluation unit 406 evaluates difference in RPE between adjacent tracks, fluctuations in track pitch and an error rate of a preamble signal of a sector number or a servo pattern and determines the evaluated result as transferred quality.

The magnetic head positioning control apparatus of the present embodiment sequentially selects each RRO current correction table as a selection table. The quality evaluation unit 406 performs the evaluation process of transferred quality described with reference to FIG. 5 to determine transferred quality obtained in the case where each RRO current correction table is selected as a selection table as transferred quality corresponding to each of the groups of servo patterns. The quality evaluation unit 406 determines the group of servo patterns that is the best in transferred quality (for example, a value is the smallest) as the best group of servo patterns (SPopt) and the RRO current correction table corresponding to the best servo pattern as the best RRO current correction table (SPopt-CC).

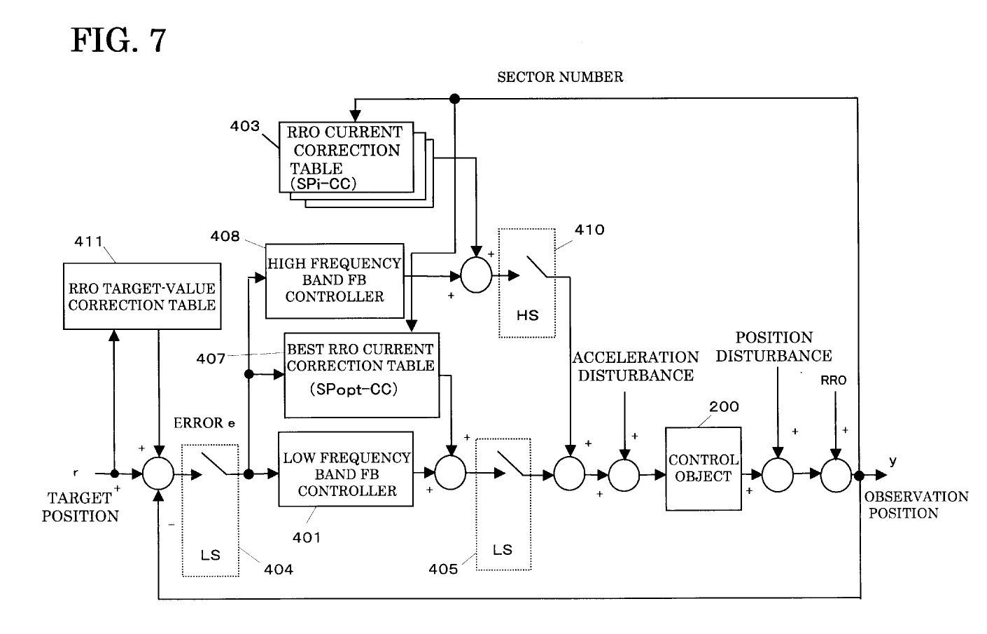

A first embodiment of the present invention is described below. FIG. 6 is a diagram showing a structure of the magnetic head positioning control apparatus according to the first embodiment of the present invention. The magnetic head positioning control apparatus is a processing apparatus for controlling the magnetic head of a magnetic disk apparatus so that the head follows a servo pattern.

The magnetic head positioning control apparatus with the control system shown in FIG. 6 causes the low-speed sampler 404 to sample an error “e” at a low speed and then inputs the sampled error to the low frequency band FB controller 401 and the high frequency band FB controller 408. The low frequency band FB controller 401 outputs a control signal (ulfb) to decrease fluctuations in the position of the magnetic head due to disturbance in a low frequency band. The high frequency band FB controller 408 outputs a control signal (uhfb) to decrease fluctuations in the position of the magnetic head due to disturbance in a high frequency band.

For the servo sectors corresponding to the best group of servo patterns (SPopt), the magnetic head positioning control apparatus adds the RRO current correction amount (ulcc) corresponding to the servo sector in the best RRO current correction table (SPopt-CC) 407 to the output (ulfb) of the low frequency band FB controller 401. The magnetic head positioning control apparatus causes the low speed sampler 405 to sample the added result at a low speed. Then, the magnetic head positioning control apparatus adds the output (uhfb) of the high frequency band FB controller 408 to produce the control input and inputs the control input to the control object 200, thereby performing the magnetic head positioning control.

For the servo sectors corresponding to other groups of servo patterns (SPi) different from the SPopt and existing between two adjacent servo sectors corresponding to the SPopt, an RRO current correction interpolation calculating unit 409 of the magnetic head positioning control apparatus calculates an RRO current correction amount for servo sectors corresponding to other groups of servo patterns by the linear interpolation calculation using an RRO current correction amount corresponding to each of two adjacent servo sectors in the SPopt-CC and outputs the calculated result as a control correction amount (uhcc). The magnetic head positioning control apparatus adds the control correction amount (uhcc) to the output (uhfb) of the high frequency band FB controller 408 and causes a high speed sampler (HS) 410 to sample the added result at a high speed. The magnetic head positioning control apparatus adds the result of the high speed sampling to the result of the low speed sampler to produce a control signal and inputs the control signal to the control object 200, thereby performing the magnetic head positioning control.

In the first embodiment of the present invention, in case where RRO is great, the magnetic head positioning control apparatus may correct a target value so that the magnetic head does not follow the RRO. For this reason, a positional trajectory is produced for each track, an error in which an observation position “y” is subtracted from a target position “r” is determined as a positional error and the positional error may be recorded in advance in an RRO target-value correction table 411 as an RRO target-value correction amount. The magnetic head positioning control apparatus may read the RRO target-value correction amount corresponding to the current sector number from the RRO target-value correction table 411 and changes the target position based on the read RRO target-value correction amount.

In the first embodiment of the present invention, for example, four groups of servo patterns (SP1, SP2, SP3 and SP4) shown in FIG. 2 are recorded in a magnetic disk. The magnetic head positioning control apparatus produces the RRO current correction tables (SP1-CC to SP4-CC) corresponding to each of the groups of servo patterns according to the control process described above with reference to FIG. 4. The magnetic head positioning control apparatus selects, for example, the SPi and SP1-CC as the best group of servo patterns SPopt and the best RRO current correction table (SPopt-CC) 407 respectively according to the control process described above with reference to FIG. 5.

The magnetic head positioning control apparatus calculates the control signal U (20) corresponding to the servo sector with a servo sector number “20” corresponding to the SP1, for example, by the following equation 1.

U(20)=ulfb(20)+ulcc(20) Equation 1.

The ulfb (20) is an output of the low frequency band FB controller 401 corresponding to the servo sector with a servo sector number “20.” The ulcc (20) is an RRO current correction amount corresponding to the servo sector in the SP1-CC.

The magnetic head positioning control apparatus calculates an RRO current correction amount (uhcc (j, k)) corresponding to the servo sector (S(j,k)) corresponding to the group of servo patterns excluding the SP1 in the following manner. The servo sector S(j,k) is a servo sector existing between the servo sector with a sector number “j” corresponding to the SP1 and the servo sector with a sector number “j+1”. The above “k” is a variable which indicates the order of a servo sector in a plurality of servo sectors in which the servo sectors (S(j, k)) range between the servo sector with a sector number “j” and the sector with a sector number “j+1.” corresponding to the SPopt (SP1 in the example). For example, when four groups of servo patters shown in FIG. 2 are recorded in the magnetic disk, 1≦k≦3, the servo sector corresponding to the SP2 is S(j, 1), the servo sector corresponding to the SP3 is S(j, 2) and the servo sector corresponding to the SP4 is S(j, 3).

The magnetic head positioning control apparatus reads the RRO current correction amount (ulcc (j)) corresponding to the servo sector with a sector number “j” and the RRO current correction amount (ulcc (j+1)) corresponding to the servo sector with a sector number “j+1” from the SPopt-CC and performs a linear interpolation calculation based on the read ulcc(j) and ulcc (j+1) to calculate the RRO current correction amount (uhcc (j, k) corresponding to the servo sector (S (j, k)). The magnetic head positioning control apparatus calculates the control input U(j, k) corresponding to the servo sector (S (j, k)) based on the calculated RRO current correction amount (uhcc (j, k)).

For example, the calculation of the control input U(20, k) corresponding to the servo sector (S (20, k)) existing between the servo sector with a servo sector number “20” and the servo sector with a servo sector number “21” corresponding to the SP1 is described as follows. The magnetic head positioning control apparatus calculates the control signal U(20, k) by the following equation 2.

U(20,k)=ulfb(20)+uhfb(20,k)+uhcc(20,k) Equation 2.

Where, the uhcc (20, k) is calculated by the following equation 3.

uhcc(20, k)=ulcc(20)+(ulcc(21)−ulcc(20))×k/4 Equation 3.

The ulcc (21) is an RRO current correction amount corresponding to the servo sector with a servo sector number “21” in the SP1-CC. The uhfb (20, k) is the output of the high frequency band FB controller 408.

A second embodiment of the present invention is described below. FIG. 7 is a diagram showing a structure of the magnetic head positioning control apparatus according to the second embodiment of the present invention. The composing elements of the magnetic head positioning control apparatus shown in FIG. 7 having the same reference numerals and characters as those of the magnetic head positioning control apparatus shown in FIG. 6 are the same as those of the magnetic head positioning control apparatus shown in FIG. 6.

For the servo sector corresponding to the best group of servo patterns (SPopt), as is the case with the magnetic head positioning control apparatus shown in FIG. 6, the magnetic head positioning control apparatus with a control system shown in FIG. 7 adds the RRO current correction amount (ulcc) corresponding to the servo sector in the best RRO current correction table (SPopt-CC) 407 to the output (ulfb) of the low frequency band FB controller 401 to produce the control input based on the calculation result.

For the servo sector (target servo sector) corresponding to other groups of servo patterns (SPi) different from the SPopt and existing between two adjacent servo sectors corresponding to the SPopt, the predetermined positioning control unit of the magnetic head positioning control apparatus outputs the RRO current correction amount corresponding to the target servo sector in the RRO current correction table (SPi-CC) 403 corresponding to the other groups of servo patterns (SPi) as the control correction amount (uhcc). The magnetic head positioning control apparatus adds the control correction amount (uhcc) to the output (uhfb) of the high frequency band FB controller 408 to produce a control signal based on the added result and inputs the control signal to the control object 200 to perform the magnetic head positioning control.

As is the case with the first embodiment of the present invention described above, suppose that four groups of servo patterns (SP1, SP2, SP3 and SP4) shown in FIG. 2 are recorded in a magnetic disk, the RRO current correction tables (SP1-CC to SP4-CC) corresponding to each of the groups of servo patterns are produced and the SP1 and the SP1-CC are selected as the best group of servo patterns (Spopt) and the best RRO current correction table (SPopt-CC) 407 respectively.

For example, the magnetic head positioning control apparatus in the second embodiment of the present invention calculates the control input U(20) corresponding to the servo sector with a servo sector number “20” corresponding to the SPi by the following equation 4.

U(20)=ulfb(20)+ulcc(20) Equation 4.

The ulfb (20) is the output of the low frequency band FB controller 401 corresponding to the servo sector with a servo sector number “20.” The ulcc (20) is an RRO current correction amount corresponding to the servo sector in the SP1-CC.

The magnetic head positioning control apparatus in the second embodiment of the present invention calculates the control signal U(20, k) corresponding to the servo sector (S (20, k)) corresponding to the groups of servo patterns excluding the SP1 existing between the servo sector with a servo sector number “20” and the servo sector with a servo sector number “21” by the following equation 5.

U(20, k)=ulfb (20)+uhfb (20, k)+uhcc (20, k) . . . . Equation 5. Where, the uhfb (20, k) is the output of the high frequency band FB controller 408. The uhcc (20, k) is an RRO current correction amount read from a table SPmod 4(p+k)−CC. The above “p” is a variable indicating the group of servo patterns selected as the SPopt. In this example, the SP1 is the SPopt, so that p=1. The mod 4(p+k) is a remainder obtained when (p+k) is divided by four. If a remainder obtained when (p+k) is divided by four is zero, the magnetic head positioning control apparatus reads an RRO current correction amount from the SP4-CC and takes the read RRO current correction amount as the uhcc (20, k).

For example, in p=1 (if the SP1 is the SPopt), if k=1, the magnetic head positioning control apparatus reads an RRO current correction amount read from the SP2-CC and takes the read RRO current correction amount as the uhcc (20, 1). If k=2, the magnetic head positioning control apparatus reads an RRO current correction amount read from the SP3-CC and takes the read RRO current correction amount as the uhcc (20, 2). If k=3, the magnetic head positioning control apparatus reads an RRO current correction amount read from the SP4-CC and takes the read RRO current correction amount as the uhcc (20, 3).

For example, in p=2 (if the SP2 is the SPopt), if k=1, the magnetic head positioning control apparatus reads an RRO current correction amount read from the SP3-CC and takes the read RRO current correction amount as the uhcc (20, 1). If k=2, the magnetic head positioning control apparatus reads an RRO current correction amount read from the SP4-CC and takes the read RRO current correction amount as the uhcc (20, 2). If k=3, the magnetic head positioning control apparatus reads an RRO current correction amount read from the SP1-CC and takes the read RRO current correction amount as the uhcc (20, 3).

In p=3 (if the SP3 is the SPopt), if k=1, the magnetic head positioning control apparatus reads an RRO current correction amount read from the SP4-CC and takes the read RRO current correction amount as the uhcc (20, 1). If k=2, the magnetic head positioning control apparatus reads an RRO current correction amount read from the SP1-CC and takes the read RRO current correction amount as the uhcc (20, 2). If k=3, the magnetic head positioning control apparatus reads an RRO current correction amount read from the SP2-CC and takes the read RRO current correction amount as the uhcc (20, 3).

In p=4 (if the SP4 is the SPopt), if k=1, the magnetic head positioning control apparatus reads an RRO current correction amount read from the SP1-CC and takes the read RRO current correction amount as the uhcc (20, 1). If k=2, the magnetic head positioning control apparatus reads an RRO current correction amount read from the SP2-CC and takes the read RRO current correction amount as the uhcc (20, 2). If k=3, the magnetic head positioning control apparatus reads an RRO current correction amount read from the SP3-CC and takes the read RRO current correction amount as the uhcc (20, 3).

What is claimed is:

1. A magnetic head positioning control method in a magnetic head positioning control apparatus for controlling a magnetic head of a magnetic disk apparatus so that the magnetic head follows a servo pattern, comprising:
providing a magnetic disk incorporated in the magnetic disk apparatus in which n groups of servo patterns, each corresponding to the predetermined number of servo sectors, are recorded; and
evaluating, in the magnetic head positioning control apparatus, the transferred quality of a servo pattern for each of the n groups of servo patterns, selecting the group of servo patterns that is the best in transferred quality as the best group of servo patterns, and performing a magnetic head positioning control using a correction amount in correction-amount storage unit corresponding to the selected best group of servo patterns, out of the correction-amount storage unit storing the correction amount corresponding to each of the n groups of servo patterns and correcting fluctuations in the position of a magnetic head in a servo sector to which a group of servo patterns corresponds.

2. The magnetic head positioning control method according to claim 1, wherein, for the servo sector corresponding to the best group of servo patterns, performing, in the magnetic head positioning control apparatus, the magnetic head positioning control based on the correction amount in the correction-amount storage unit corresponding to the best group of servo patterns, and for a servo sector corresponding to other groups of servo patterns different from the best group of servo patterns and existing between two servo sectors corresponding to the best group of servo patterns, calculating, in the magnetic head positioning control apparatus, a correction amount corresponding to servo sector corresponding to other groups of servo sectors by a linear interpolation calculation using a correction amount corresponding to each of the two servo sectors in the correction-amount storage unit corresponding to the best group of servo patterns and performing the magnetic head positioning control based on the calculated correction amount.

3. The magnetic head positioning control method according to claim 1, wherein, for the servo sector corresponding to the best group of servo patterns, performing, in the magnetic head positioning control apparatus, the magnetic head positioning control based on the correction amount in the correction-amount storage unit corresponding to the best group of servo patterns, and for the servo sectors corresponding to other groups of servo patterns different from the best group of servo patterns and existing between two servo sectors corresponding to the best group of servo patterns, performing, in the magnetic head positioning control apparatus, the magnetic head positioning control based on the correction amount in the correction-amount storage unit corresponding to other groups of servo patterns different from the best group of servo patterns.

4. A magnetic head positioning control apparatus which controls a magnetic head of a magnetic disk apparatus so that the magnetic head follows a servo pattern, wherein, n groups of servo patterns, each corresponding to the predetermined number of servo sectors, are recorded in a magnetic disk incorporated in the magnetic disk apparatus, the magnetic head positioning control apparatus comprising:
a quality evaluation unit evaluating the transferred quality of a servo pattern for each of the n groups of servo patterns and selecting the group of servo patterns that is the best in transferred quality as the best group of servo patterns; and
a positioning control unit performing a magnetic head positioning control using a correction amount in correction-amount storage unit corresponding to the selected best group of servo patterns, out of a correction-amount storage unit storing the correction amount corresponding to each of the n groups of servo patterns and correcting fluctuations in the position of a magnetic head in a servo sector to which a group of servo patterns corresponds.

5. The magnetic head positioning control apparatus according to claim 4, wherein, for the servo sector corresponding to the best group of servo patterns, the positioning control unit performs the magnetic head positioning control based on the correction amount in the correction-amount storage unit corresponding to the best group of servo patterns, and for the servo sectors corresponding to other groups of servo patterns different from the best group of servo patterns and existing between two servo sectors corresponding to the best group of servo patterns, the positioning control unit calculates a correction amount corresponding to servo sector corresponding to other groups of servo sectors by a linear interpolation calculation using a correction amount corresponding to each of the two servo sectors in the correction-amount storage unit corresponding to the best group of servo patterns and performs the magnetic head positioning control based on the calculated correction amount.

6. The magnetic head positioning control apparatus according to claim 4, wherein, for the servo sector corresponding to the best group of servo patterns, the positioning control unit performs the magnetic head positioning control based on the correction amount in the correction-amount storage unit corresponding to the best group of servo patterns, and for the servo sectors corresponding to other groups of servo patterns different from the best group of servo patterns and existing between two servo sectors corresponding to the best group of servo patterns, the positioning control unit performs the magnetic head positioning control based on the correction amount in the correction-amount storage unit corresponding to other groups of servo patterns different from the best group of servo patterns.
